(19) United States
(12) Patent Application Publication
(10) Pub. No.: US 2007/0073971 A1
(43) Pub. Date: Mar. 29, 2007

(54) Memory caching in data processing

(76) Inventors: Rabin Ezra, Barking (GB); Solomon Ezra, Barking (GB)

Correspondence Address: KATTEN MUCHIN ROSENMAN LLP, 575 MADISON AVENUE, NEW YORK, NY, 10022-2585, US

(21) Appl. No.: 11/430,264

(22) Filed: May 8, 2006

(30) Foreign Application Priority Data
May 9, 2005 (GB) 0509420.6

(51) Int. Cl. G06F 13/28

(52) U.S. Cl. 711/123

(57) ABSTRACT

A data processor comprises a main memory; an instruction cache and a data cache; instruction fetch logic operable to search the instruction cache for a required instruction; and if the required instruction is not present in the instruction cache, to search the data cache; and if the required instruction is not present in the data cache, to fetch the required instruction from the main memory to the instruction cache; data write logic operable to write a data value into the data cache at a data address and, if that address is also represented in the instruction cache, to write that data value into the instruction cache; and cache control logic operable to transfer data from the data cache to the main memory.

### BACKGROUND OF THE INVENTION

1. Field of the Invention

This invention relates to memory caching in data processing.

2. Description of the Prior Art

An example problem will now be described with respect to emulation of a particular microprocessor, but it will be appreciated that the invention has much wider applicability.

Microprocessor cores are used in various applications such as television set top boxes and the Sony^{RTM} Playstation 2™ (PS2) family computer entertainment system. In the PS2's input/output processor (IOP), the core is provided with 2 Megabytes of main memory and a very small cache. It makes use of so-called cache “write through”, where any information written back by the processor to a cached memory location is also written to the underlying main memory. This means that the new information is written to the cache in case it is needed to be read again soon, but the write operation itself is not cached because a main memory access is still needed each time. One advantage of this arrangement is that it allows self-modifying program code to be implemented more easily.

It has been proposed that the IOP be emulated by an emulation processor having an internal memory too small to provide the 2 MB of the IOP's memory. An external memory can be accessed, but this is only via a DMA controller. To allow the emulation to operate at a useful rate, a caching strategy is therefore required, because accesses to an external memory in the emulating system using the DMA controller are slow. To cut down on the number of external memory accesses which are needed, the caching strategy should include the caching of data writes as well as data reads. However, this would mean that self-modifying code cannot easily be emulated.

### SUMMARY OF THE INVENTION

This invention provides a data processor comprising:

a main memory;

an instruction cache and a data cache;

instruction fetch logic operable to search the instruction cache for a required instruction; and if the required instruction is not present in the instruction cache, to search the data cache; and if the required instruction is not present in the data cache, to fetch the required instruction from the main memory to the instruction cache;

data write logic operable to write a data value into the data cache at a data address and, if that address is also represented in the instruction cache, to write that data value into the instruction cache; and

cache control logic operable to transfer data from the data cache to the main memory.

The invention provides an efficient way of accessing data and instructions while reducing the need to access a main memory.

Viewed from a second aspect this invention provides a data processing method in a system having a main memory, an instruction cache and a data cache;

the method comprising the steps of:

searching the instruction cache for a required instruction;

if the required instruction is not present in the instruction cache, searching the data cache;

if the required instruction is not present in the data cache, fetching the required instruction from the main memory to the instruction cache;

when a data value is to be written, writing that data value into the data cache at a data address and, if that address is also represented in the instruction cache, writing that data value into the instruction cache; and

transferring data from the data cache to the main memory.

Further aspects of the invention include computer software comprising program code to carry out this method; and a medium (e.g. a transmission medium or a storage medium) by which such program code is provided.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 schematically illustrates a data processing system;

FIG. 2 schematically illustrates a data processing system using data and instruction caches;

FIG. 3 is a schematic flow chart relating to an operation to read an instruction;

FIG. 4 is a schematic flow chart relating to an operation to write a data value; and

FIG. 5 is a schematic flow chart relating to an operation to read a data value.

### DESCRIPTION OF THE PREFERRED EMBODIMENTS

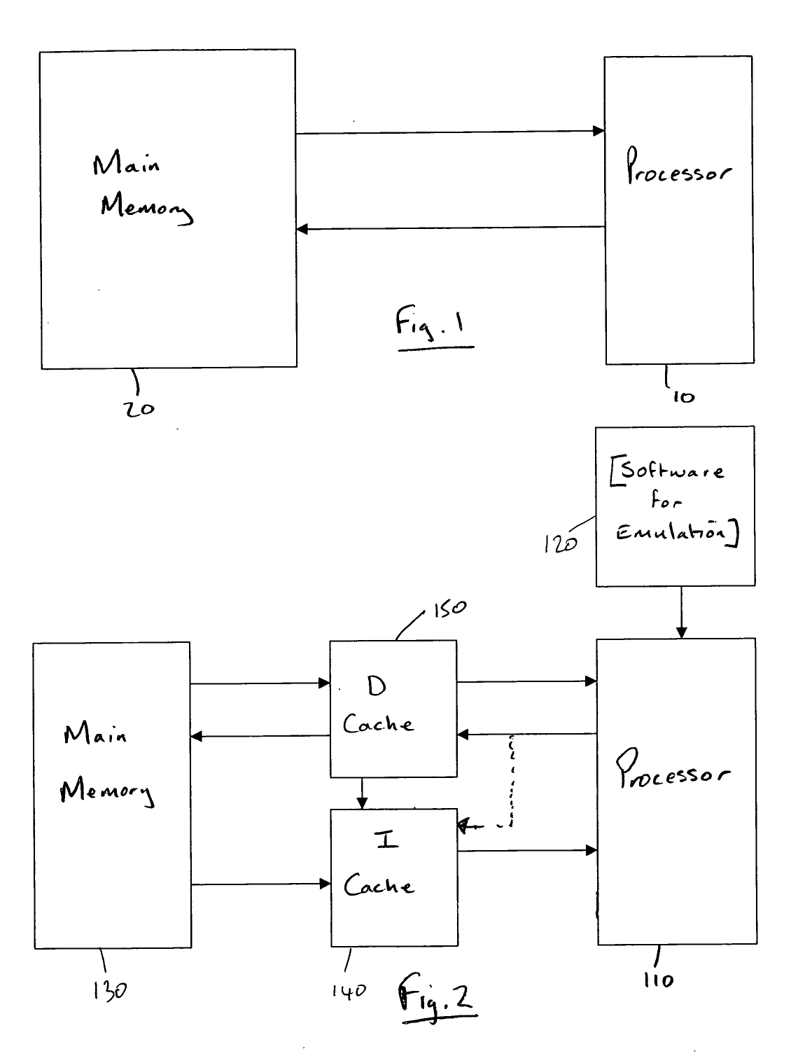

FIG. 1 schematically illustrates a data processing system to be emulated. The system comprises a processor 10 which reads data and instructions from, and writes data and modified instructions to, a main memory 20.

The following description relates to a technique for emulating the operation of the system of FIG. 1 using a processor whose local memory is too small to hold an image of the main memory 20 of the system to be emulated. Because of this restriction, a cache strategy has to be employed.

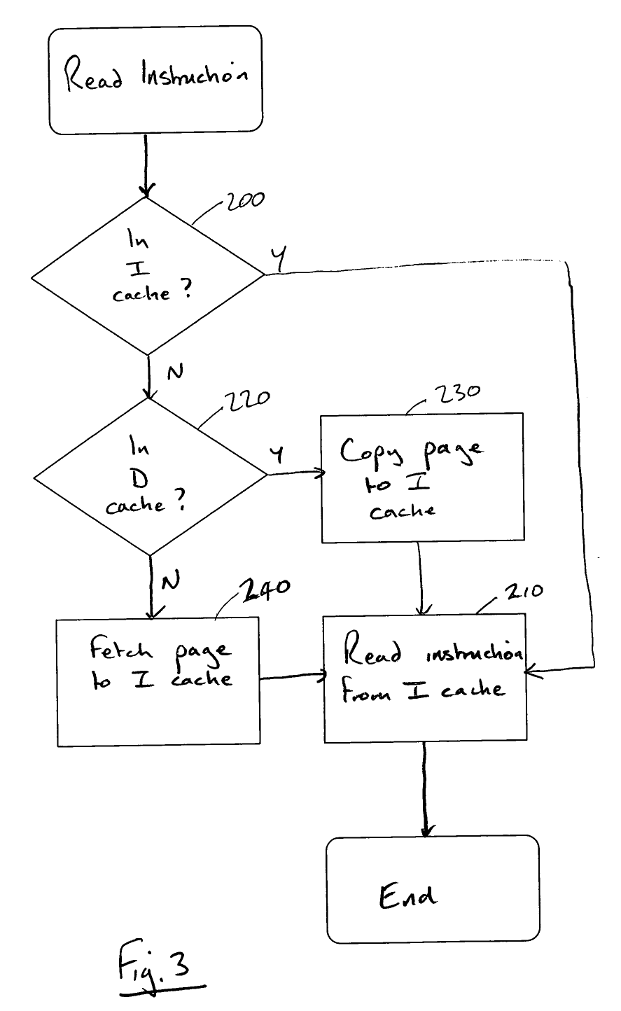

FIG. 2 schematically illustrates the emulation arrangement. Emulation techniques are generally well known, and features which are not directly relevant to the present embodiment are omitted for clarity. Emulation involves an emulation processor running emulation software written in a language native to the emulation processor, so that a group of such native instructions are run in order to emulate the handling of an instruction in the emulated system. In the description which follows, the term “instruction” will refer to an instruction in the emulated system, and not to a native instruction of the emulation software.

Referring to FIG. 2, a processor 110 running emulation software 120 accesses a main memory 130 via an instruction cache (I) 140 and a data cache (D) 150. The reason that the I cache and the D cache are used is that the memory local to the processor 110 is too small to hold an image of the main memory 20 of the emulated system, and the main memory 130 associated with the processor 110 has to be accessed via an expensive (i.e. time consuming) DMA accesses.

The I cache 140 is direct mapped for speed of access and holds 8 memory pages of 4 kilobytes each (i.e. each page holds plural cache lines). A small number of large memory pages are used in this embodiment to make the process of checking for a cache hit more efficient. Large memory pages amortize slow memory accesses. Memory pages may be read from the main memory 130 into the I cache 140, and the processor may read instructions from the I cache 140. However, values stored in the I cache 140 are never written back to the main memory 130.

Transfers to and from caches are made on a page by page basis. Similarly, the searching of a cache, to detect whether a required data item is held, is carried out by detecting whether the page containing that item is held in the cache.

The D cache 150 is fully associative to reduce so-called “thrashing”—i.e. a rapid changing of the cached pages—and again holds 8 pages of 4 kilobytes each. When a new page is to be read into the D cache from the main memory 130, a least-recently-accessed page stored in the D cache is written back to the main memory (if it has been changed since it was read from the main memory). So, if the processor modifies any stored data in the D cache, the modification is held in the D cache 150 until that page is written back to the main memory 130.

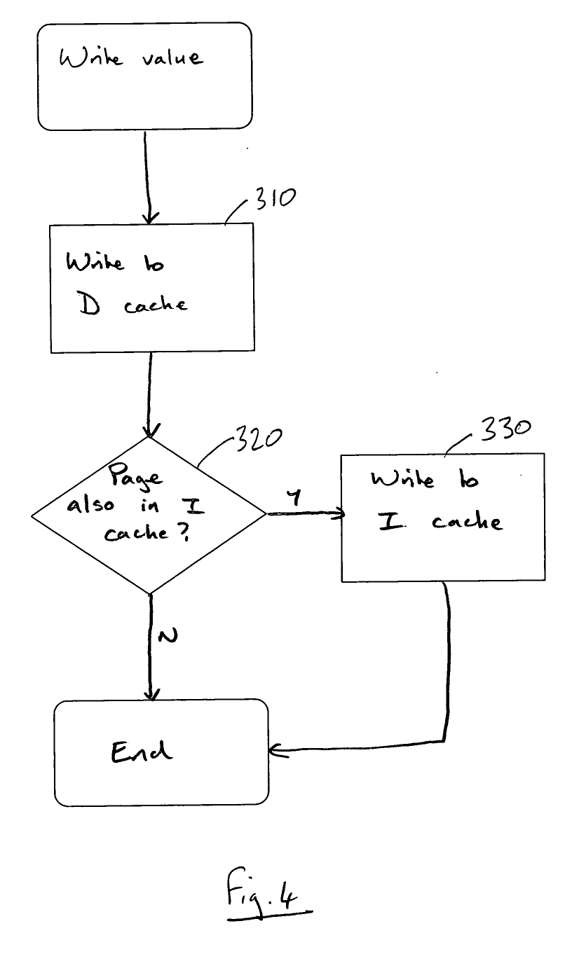

The interaction of the D cache and the I cache will now be described with reference to flowcharts shown in FIGS. 3 to 5.

FIG. 3 is a schematic flowchart relating to an operation to read an instruction.

At a step 200, the processor 110 attempts to access the required instruction from the I cache 140. If the required instruction is present in the I cache 140, control passes to a step 210 where the instruction is read from the I cache and passed to the processor 110 for handling in the usual way. The process then ends.

However, if the required instruction was not in the I cache 140, a check is then made as to whether the required instruction is part of the information stored in the D cache 150. This test is represented by a step 220. If the required instruction is indeed in the D cache, then the whole page is copied from the D cache to the I cache at a step 230. Note that this can simply overwrite a page in the I cache, because data from the I cache is never written back to the main memory 130. From the step 230 control again passes to the step 210 at which the required instruction is read from the I cache and the processor ends.

If, however, the required instruction is neither in the I cache (step 200) nor the D cache (step 220) then at a step 240 the page containing the required instruction is read from the main memory to the I cache 140, overwriting a page in the I cache. Control again passes to the step 210 and the process ends.

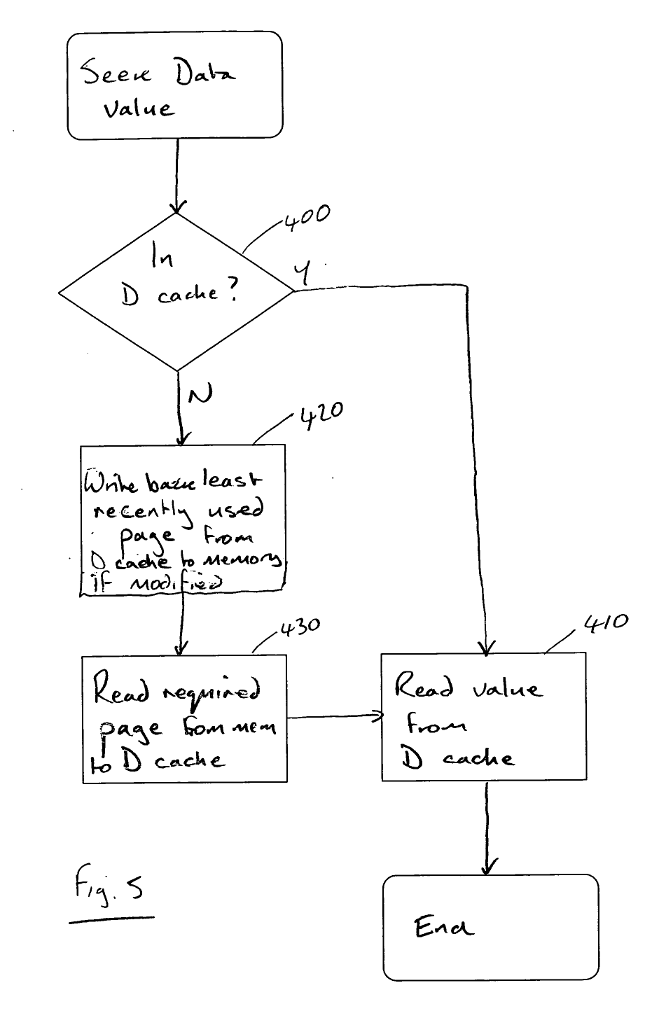

FIG. 4 is a schematic flowchart relating to an operation to write a data value.

At a step 310, the processor 110 writes a data value to the D cache 150. As described above, this will eventually be used to update the main memory 130, though this may not happen until the relevant page has to be overwritten in the D cache.

At a step 320, a detection is made as to whether the page containing the newly written data value is also held in the I cache. If it is then at a step 330 the new data value is also written to the relevant position in the I cache and the process ends. If, however, the relevant page was not held in the I cache, the process would simply end there.

FIG. 5 is a schematic flowchart relating to an operation to read a data value. At a step 400, the processor 110 attempts to access the data value from the D cache 150. If the required address is cached in the D cache 150, then the required value is read from the D cache at a step 410 and the process ends. If, however, the necessary page is not in the D cache, then at a step 420 the least-recently used page is written back (if required, i.e. if it has been modified) from the D cache to the main memory 130, and at a step 430 the page containing the required memory address is read from the main memory 130 to the D cache 150. Control then passes again to the step 410 and the process ends.

Using the strategy above, even though information stored in the I cache 140 is never directly written back to the main memory 130 and no I cache invalidate instruction or function is provided in the present embodiment, if the processor 110 runs so-called self-modifying code so that instructions stored in the main memory 130 are to be overwritten by instructions generated by means of running the instructions themselves, there is no chance of an inconsistency in the code to be run. Where an instruction is to be overwritten, the new value is written to the D cache and, if that page is also stored in the I cache, it is written to the I cache. So, the I cache is kept up to date with any changes. At the time of an instruction is to be accessed, if it is not in the I cache, the D cache is searched before the main memory. So, any changes not yet written back to main memory 130 will still be in the D cache and the modified instructions will be transferred from the D cache to the I cache.

Although illustrative embodiments of the invention have been described in detail herein with reference to the accompanying drawings, it is to be understood that the invention is not limited to those precise embodiments, and that various changes and modifications can be effected therein by one skilled in the art without departing from the spirit and scope of the invention as defined by the appended claims.

I claim:

1. A data processor comprising:
a main memory;
an instruction cache;
a data cache;
instruction fetch logic operable to search said instruction cache for a required instruction; and if said required instruction is not present in said instruction cache, to search said data cache; and if said required instruction is not present in said data cache, to fetch said required instruction from said main memory to said instruction cache;
data write logic operable to write a data value into said data cache at a data address and, if that address is also represented in said instruction cache, to write that data value into said instruction cache; and
cache control logic operable to transfer data from said data cache to said main memory.

2. A data processor according to claim 1, in which said instruction cache is direct mapped and said data cache is fully associative.

3. A data processor according to claim 1, in which said caches are arranged as multiple cache pages.

4. A data processor according to claim 3, in which transfers to or from a cache are carried out on a page-by-page basis.

5. A data processor according to claim 3, in which said instruction fetch logic is operable to search said instruction cache and said data cache by detecting whether a required page is held in the respective cache.

6. A data processor according to claim 3, in which said cache control logic is arranged to transfer a least-recently-accessed page of data from said data cache to said main memory when a newly required page is to be written into said data cache and that least-recently accessed page contains data which has been modified.

7. A data processor according to claim 3, in which, when a required instruction is not present in said instruction cache or said data cache, said instruction fetch logic is operable to fetch a page containing said required instruction from said main memory to said instruction cache.

8. A data processor according to claim 3, in which each of said caches holds 32 kilobytes arranged as 8 pages of 4 kilobytes each.

9. A data processor according to claim 1, comprising instruction execution logic for executing instructions.

10. A data processor according to claim 9, in which said instruction execution logic comprises a data processing arrangement running software to emulate the execution of said instructions.

11. A data processor according to claim 1, said data processor not providing a function of invalidating entries in said instruction cache.

12. A data processing method in a system having a main memory, an instruction cache and a data cache;
said method comprising the steps of:
searching said instruction cache for a required instruction;
if said required instruction is not present in said instruction cache, searching said data cache;
if said required instruction is not present in said data cache, fetching said required instruction from said main memory to said instruction cache;
when a data value is to be written, writing that data value into said data cache at a data address and, if that address is also represented in said instruction cache, writing that data value into said instruction cache; and
transferring data from said data cache to said main memory.

13. Computer software comprising program code to carry out a method according to claim 12.

14. A medium by which program code according to claim 13 is provided.

15. A medium according to claim 14, said medium being a transmission medium.

16. A medium according to claim 14, said medium being a storage medium.
